(19) United States
(12) Patent Application Publication
(10) Pub. No.: US 2026/0063242 A1
(43) Pub. Date: Mar. 5, 2026

(54) Adjustable Mounting Assembly with Internal Indexing System

(71) Applicant: Sonos, Inc., Goleta, CA (US)

(72) Inventors: Jake Chervin, Boston, MA (US); Felix Carlsson, Malmo (SE); Robin Gustafsson, Malmo (SE); Ernesto Figueira, Cambridge, MA (US); Paolo von Krogh, Malmo (SE); Rasmus Breitholtz, Malmo (SE)

(21) Appl. No.: 19/319,351

(22) Filed: Sep. 4, 2025

Related U.S. Application Data
(60) Provisional application No. 63/691,254, filed on Sep. 5, 2024.

(51) Int. Cl. F16M 13/02; F16M 11/14

(52) U.S. Cl. CPC F16M 13/02; F16M 11/14; F16M 2200/024

(57) ABSTRACT

An adjustable mounting assembly includes a housing including a front collar and a rear collar joined by a threaded engagement, an internal indexing system comprising a front member, an intermediate member comprising teeth oriented towards the rear collar, a rear member comprising a first rib oriented towards the front collar and a second rib oriented towards the rear collar, and a spring arranged to bias the first and second ribs into the teeth. When the threaded engagement is in first position, the first and second ribs are fixed in an interlocking engagement, respectively, with the teeth of the intermediate member and the teeth of the rear collar, preventing the front member from rotating about either a pitch or yaw axis and when the threaded engagement is in a second position, these engagements are loosened, thereby allowing the front member to rotate about the yaw or pitch axis.

### CROSS REFERENCE TO RELATED APPLICATIONS

This application claims priority to U.S. Provisional Application No. 63/691,254, filed Sep. 5, 2024, and titled “Adjustable Mounting Assembly with Internal Indexing System,” the contents of which are incorporated herein by reference in their entirety.

### FIELD OF THE DISCLOSURE

The present disclosure is related to consumer goods and, more particularly, to mounting assemblies that may be used to mount consumer goods, such as loudspeakers for the purpose of media playback.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. In addition, Sonos has continued to innovate around ways to physically incorporate playback devices into a listening environment, including innovations around playback device size, shape, configuration, and placement.

Given the ever-growing interest in high-quality media playback, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1A shows a perspective view of an adjustable mounting assembly, according to an example implementation;

FIG. 1B shows an exploded perspective view of the adjustable mounting assembly of FIG. 1A, according to an example implementation;

FIG. 2A shows a cross-sectional view of an adjustable mounting assembly in a first position, according to an example embodiment;

FIG. 2B shows a cross-sectional view of the adjustable mounting assembly of FIG. 2A in a second position;

FIG. 3A shows another cross-sectional view of an adjustable mounting assembly in a first position, according to an example embodiment;

FIG. 3B shows a cross-sectional view of the adjustable mounting assembly of FIG. 3A in a second position;

FIG. 4A shows a perspective view of an intermediate member of an internal indexing system of an adjustable mounting assembly, according to an example embodiment;

FIG. 4B shows a two-dimensional front view of the intermediate member of FIG. 4A;

FIG. 5A shows a two-dimensional front view of a rear cover of an adjustable mounting assembly, according to an example embodiment;

FIG. 5B shows a side perspective view of the rear cover of FIG. 5A;

FIG. 6A shows a two-dimensional front view of a mounting bracket of an adjustable mounting assembly, according to an example embodiment;

FIG. 6B shows a perspective view of the mounting bracket of FIG. 6A; and

FIG. 7 shows an example flowchart for adjusting an adjustable mounting assembly, according to an example embodiment.

The drawings are for the purpose of illustrating example embodiments and are not necessarily to scale. It is understood that the inventions are not limited to the arrangements and instrumentalities shown in the drawings.

### DETAILED DESCRIPTION

### I. Overview

Examples described herein involve an adjustable mounting assembly that may support an object having substantial weight while still providing the range of movement of a traditional ball joint. In particular, the adjustable mounting assembly discussed below may include a housing with an adjustable collar that may be loosened to permit indexed movement of an internal mounting body with multiple degrees of freedom, and alternatively tightened to fix the mounting body in an interlocking engagement with the collar, thereby preventing movement about at least one axis, such as a pitch axis or a yaw axis or both. This indexed movement is achieved via use of an internal indexing system that is disclosed herein.

Typically, a mounting assembly that utilizes a ball joint connection will provide a high degree of adjustability. The ball joint will generally hold the mounted object in a fixed position due to the friction of the ball against a socket, while still allowing rotation of the ball within the socket if enough force is applied to make an adjustment. Because of how the ball moves within the socket, adjustments may take the form of rotations about one or more of three different rotational axes including pitch, yaw, and roll. A common example of this type of mounting assembly is found in the rear-view mirror on the windshield of most cars, which allows the mirror to be rotated about one or more of a pitch axis (i.e., tilted up or down), a yaw axis (i.e., turned left of right), or a roll axis (i.e., rotated like a screw).

In many applications, a loudspeaker is an object that can benefit from being mounted in an adjustable way. For instance, in the context of a home media playback system, a user might want to place a loudspeaker (also referred to herein as an audio playback device, or playback device) at a particular location for listening purposes, but there may not be a convenient surface (e.g., a table, a shelf, etc.) upon which to place the playback device. One such example may involve a home theater arrangement where a set of playback devices may be placed at designated locations to create a particular surround sound effect. To arrange their playback devices in the correct locations, users will often mount one or more of the devices on a surface (e.g., a wall, a ceiling), or on a stand. Once mounted, the user may further wish to direct the output of the playback device in a particular direction, depending on the layout of the listening environment. Thus, the direction of the mount may be adjustable to allow for flexibility in this regard.

In many implementations, a mounting assembly that includes a ball joint may be suitable for this purpose. In some examples, a ball joint may be advantageous for mounting playback devices, as it can reduce vibration in a playback device mount that causes unwanted noise (e.g., buzzing caused by friction between parts in a mount).

However, as expectations increase for high quality audio reproduction and highly feature-capable playback devices, the physical weight of such playback devices also increases due to the hardware requirements for achieving this level of quality. This, in turn, creates a problem for traditional ball joint type mounting attachments. In particular, the weight of the playback device may be too great for the friction of the ball joint to maintain the playback device in position once the user adjusts it to its desired orientation.

Some solutions to address this issue might involve increasing the radius of the ball to create a greater surface area, and thus more friction, in contact with the socket. However, as the weight of a playback devices increases (e.g., 5 pounds or more), the radius that would be required for the ball to achieve enough friction may increase to several inches or more, and eventually becomes impractical to implement in a mount, as well as becomes potentially visually unattractive.

In an example solution that addresses some of these shortcomings, Sonos, Inc. has invented adjustable mounting assemblies, such as those disclosed in U.S. patent application Ser. No. 18/478,312, entitled “Adjustable Mounting Assembly,” (the '312 application) which is commonly owned by Applicant, Sonos, Inc., and incorporated by reference herein in its entirety. These adjustable mounting assemblies may include a housing that includes a two-part collar that is joined by a threaded engagement. An approximately spherical, multi-part body may be positioned within this housing and surrounded by the two parts of the collar, with a stem that extends through an opening in the collar that provides the mounting interface (e.g., a platform) for the playback device. When the threaded engagement of the collar is loosened, the multi-part body may move freely within the collar, rotating in each of a pitch, yaw, and roll direction based on the interfaces between the component parts of the body. On the other hand, when the threaded engagement of the collar is tightened, the multi-part body may be positioned into an interlocking engagement with the collar such that rotation in the pitch axis is prevented. For instance, the multi-part body and the collar may include opposing teeth that are engaged when the collar is tightened so as to prevent pitch rotations, but are disengaged when the collar is loosened.

While the adjustable mounting assemblies of the '312 application may be suitable for mounting loudspeakers (or other playback devices) in the context of some home media playback systems, other settings in which media playback is desired may require further mounting and/or adjustability features for use in mounting loudspeakers. For example, in a commercial setting, loudspeakers may be desirably placed in locations that are at a height at which people within the commercial setting cannot easily reach the loudspeakers. Thus, when at such a height, people within the commercial setting cannot access the loudspeakers and, therefore, cannot affect playback that is occurring via the loudspeakers (e.g., by touching control mechanisms, moving position of the loudspeakers, etc.) nor can people within the commercial setting easily remove the loudspeakers from the commercial setting.

However, when loudspeakers are to be mounted in higher heights, installation and subsequent positioning of the loudspeakers, via adjustable mounting assemblies, becomes more challenging. For example, an installer of the adjustable mounting assemblies (and/or the loudspeakers thereon) may need to balance on a ladder or other elevating mechanism. The elevation and potential loss of balance by the installer, from the elevation, may result in less precision by the installer when mounting and/or positioning the loudspeakers.

Thus, if an adjustable mounting assembly implements a threaded engagement for preventing rotation about one or more axes when the threaded engagement is tightened (e.g., as in the examples of the '312 application), the free motion when the threaded engagement is loosened may not be desirable when such an installer's precision is lessened due to some condition in the mounting environment (e.g., a desired location for the loudspeaker, an elevation of the loudspeaker, an installer's reach, etc.).

Accordingly, rather than providing free motion when the threaded engagement is in the loosened position, new adjustable mounting assemblies that are disclosed herein may include an internal indexing system that reduces or eliminates free motion about one or more axes, via the ball joint, but still enables an installer to rotate a mounting body about one or more axes. To that end, the internal indexing system may include a plurality of members that are engaged with one another (via engagement features, e.g., teeth or ribs of said members) when the collar is both tightened and loosened. This engagement may be achieved via use of a spring or similar biasing member of the internal indexing system that biases these engagement features against one another and has a biasing force that is configured to allow the members to be indexable, with respect to one another, when the threaded engagement is in the loosened position.

In this way, the adjustable mounting assembly may support the weight of a playback device via both the interlocking engagement of the housing and the spring-biased force provided by the internal indexing system.

Moreover, the interlocking engagement of the multi-part body and the collar can be achieved even if the multi-part body has been rotated in one or more directions when the collar is tightened, as will be discussed further below.

Still further, despite the sophisticated inner workings, the adjustable mounting assembly approximates the ease of use and simplistic visual aesthetics of a traditional ball joint type mounting attachment.

As indicated above, the examples herein involve an adjustable mounting assembly that may support an object having substantial weight while still providing the range of movement of a traditional ball joint. In one aspect, an adjustable mounting assembly is provided that includes (i) a housing comprising a front collar and a rear collar joined by a threaded engagement, the front collar comprising an opening about a roll axis of the mounting assembly, the rear collar comprising teeth oriented toward the front collar, (ii) an internal indexing system comprising (a) a front member positioned within the housing and extending outwardly through the opening, (b) an intermediate member positioned within the housing and rotatably engaged, about the roll axis of the mounting assembly, with the front member, the intermediate member comprising teeth oriented towards the rear collar, (c) a rear member positioned within the housing between the rear collar and the intermediate member, the rear member comprising a first rib oriented towards the front collar and a second rib oriented towards the rear collar, and (d) a spring positioned within the housing, the spring arranged to bias (1) the first rib into the teeth of the intermediate member and (2) the second rib into the teeth of the rear collar. In this aspect, the adjustable mounting assembly is adjustable such that (i) when the threaded engagement between the front collar and the rear collar is tightened to a first position, the first rib is fixed in an interlocking engagement with the teeth of the intermediate member and the second rib is fixed in an interlocking engagement with the teeth of the rear collar, thereby preventing the front member from rotating about either a pitch axis or a yaw axis of the mounting assembly and (ii) when the threaded engagement between the front collar and the rear collar is loosened to a second position, the first rib is moveable over the teeth of the intermediate member by compressing the spring or the second rib is moveable over the teeth of the rear collar by compressing the spring, thereby allowing the front member to rotate about the yaw axis or the pitch axis of the mounting assembly.

In another aspect, a method of adjusting an adjustable mounting assembly is provided, the adjustable mounting assembly comprising (a) a housing comprising a front collar and a rear collar joined by a threaded engagement, the front collar comprising an opening about a roll axis of the mounting assembly, the rear collar comprising teeth oriented toward the front collar and (b) an internal indexing system comprising (i) a front member positioned within the housing and extending outwardly through the opening; (ii) an intermediate member positioned within the housing and rotatably engaged, about the roll axis of the mounting assembly, with the front member, the intermediate member comprising teeth oriented towards the rear collar; (iii) a rear member positioned within the housing between the rear collar and the intermediate member, the rear member comprising a first rib oriented towards the front collar and a second rib oriented towards the rear collar; and (iv) a spring positioned within the housing, the spring arranged to bias (A) the first rib into the teeth of the intermediate member and (B) the second rib into the teeth of the rear collar. The method includes (a) loosening the threaded engagement between the front collar and the rear collar from a first position to a second position, thereby (i) enabling the first rib to move over the teeth of the intermediate member by compressing the spring, (ii) enabling the second rib to move over the teeth of the rear collar by compressing the spring and (iii) allowing the front member to rotate about either a pitch axis or a yaw axis of the adjustable mounting assembly, (b) after loosening the threaded engagement to the second position, rotating at least the front member about the pitch axis or the yaw axis of the adjustable mounting assembly, and (c) after rotating at least the front member about the pitch axis or the yaw axis, tightening the threaded engagement between the front collar and the rear collar from the second position to the first position, thereby (i) fixing the first rib in an interlocking engagement with the teeth of the intermediate member, (ii) fixing the second rib in an interlocking engagement with the teeth of the rear collar, and (iii) preventing the front member from rotating about either the pitch axis or the yaw axis of the adjustable mounting assembly.

It will be understood by one of ordinary skill in the art that this disclosure includes numerous other embodiments. While some examples described herein may refer to functions performed by given actors such as “users” and/or other entities, it should be understood that this description is for purposes of explanation only. The claims should not be interpreted to require action by any such example actor unless explicitly required by the language of the claims themselves.

While some examples described herein may refer to functions performed by given actors such as “users” and/or other entities, it should be understood that this is for purposes of explanation only. The claims should not be interpreted to require action by any such example actor unless explicitly required by the language of the claims themselves.

### II. Example Adjustable Mounting Assembly

Embodiments described herein involve configurations of an adjustable mounting assembly, as well as operating and assembling of an adjustable mounting assembly.

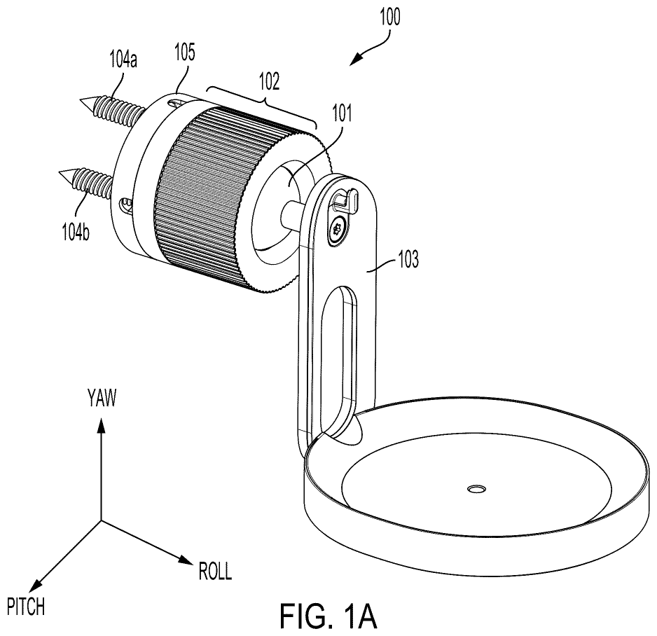

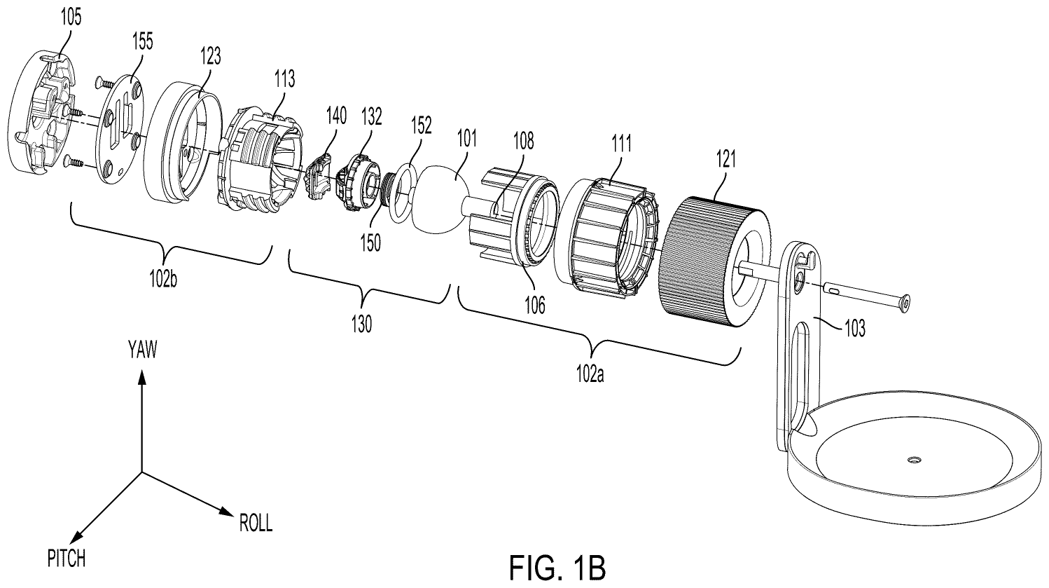

Turning to FIG. 1A, a perspective view of an adjustable mounting assembly 100 is shown. The adjustable mounting assembly 100 includes a housing 102 that is divided into front and rear portions. Extending through an opening in the front of the housing is a front member 101, which may be seen more clearly in subsequent figures. A platform 103 for receiving an audio playback device is attached to a stem of the front member 101 and serves as a mounting interface for the object that is to be mounted.

In this regard, the platform 103 shown in FIG. 1A represents just one of many possible mounting interfaces that might be included as part of the adjustable mounting assembly 100. Moreover, although the examples discussed herein generally refer to the mounting of playback devices, it will be appreciated that the adjustable mounting assembly 100 may be used for mounting various different objects. For instance, the platform 103 might have a different shape than shown in FIG. 1A in order to conform to a particular playback device or other object (e.g., a display such as a television, a security camera, a floodlight, etc.). Further, the platform 103 might be replaced in some implementations by a bracket or other type of fastener that may be used to couple the object to be mounted to the adjustable mounting assembly 100. Other examples are also possible.

The adjustable mounting assembly 100 shown in FIG. 1A also includes a mounting bracket 105 removably coupled to the rear exterior side of the housing 102. A pair of fasteners extends through openings in the mounting bracket 105, shown in FIG. 1A as a first screw 104a and a second screw 104b, although various other fasteners may also be used.

To illustrate various internal components of the adjustable mounting assembly 100, FIG. 1B shows the adjustable mounting assembly 100 in an exploded view that reveals components of the adjustable mounting assembly 100 that otherwise would be obscured by the housing 102, when the adjustable mounting assembly 100 is assembled. To that end, FIG. 1B shows components of the housing 102, components of an internal indexing system 130, the platform 103, and the mounting bracket 105. More detailed descriptions of these components are provided below.

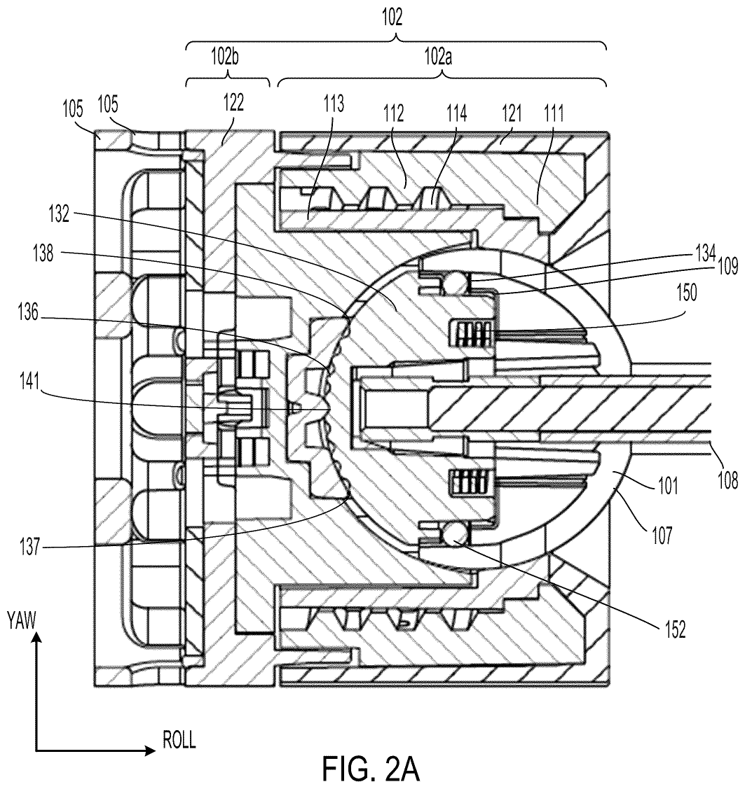

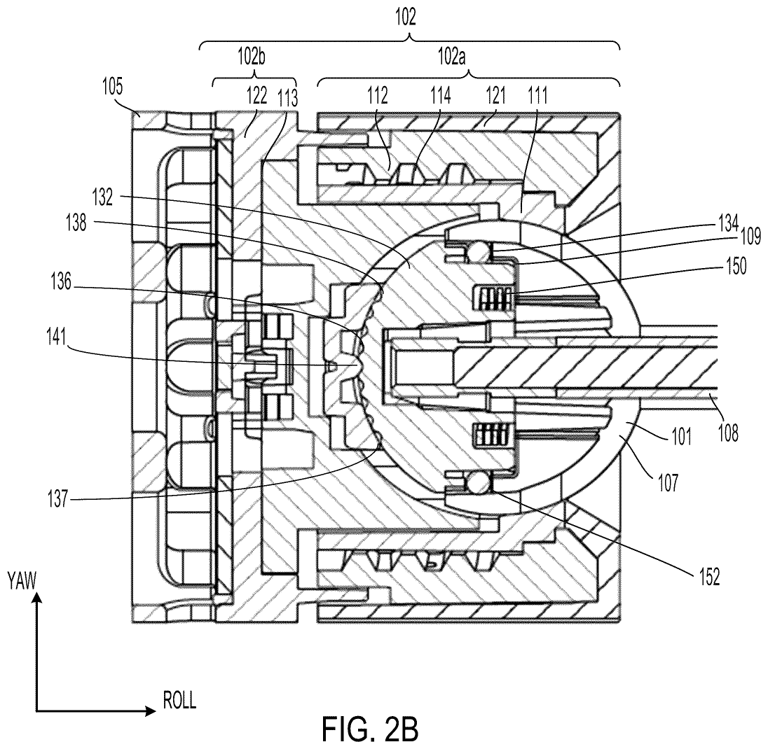

As can be seen in FIG. 1B, the housing 102 may be divided into two parts-a front housing portion 102a and a rear housing portion 102b. The front housing portion 102a includes a front collar 111, a front cover 121 surrounding the front collar 111, and a bearing collar 106. Each the front collar 111, the front cover 121, and the bearing collar 106 include an opening (i.e., on the right side of the front housing portion 102a in FIG. 2A) about a roll axis of the adjustable mounting assembly 100. The rear housing portion 102b includes a rear cover 123 surrounding, in part, a rear collar 113, which is joined with the front collar 111 via a threaded engagement. In some examples, the rear housing portion may include a rear wall 155 that is engageable, in conjunction with the rear cover 123, with the mounting bracket 105.

The internal indexing system 130 may include the front member 101, an intermediate member 132, a rear member 140, and a spring 150. The front member 101 may be positioned within the housing 102 and may comprise a stem 108 that extends outwardly through an opening in the housing 102. The intermediate member 132 may be positioned within the housing 102 and rotatably engaged with the front member 101 (e.g., about the roll axis of the adjustable mounting assembly 100). Positioned within the housing 102 and between the rear collar 113 and the intermediate member 132, the rear member 140 may include ribs that engage with opposing teeth on both the rear collar 113 and the intermediate member 132, as will be discussed in more detail below. Further, the spring 150 may be positioned within the housing 102 and configured to bias the intermediate member 132 away from the front member 101, thereby forcing the ribs and opposing teeth of the intermediate member 132, the rear member 140, and the rear collar 113 against each other.

In some examples, the internal indexing system 130 may include a gasket 152 that provides some friction between components of the internal indexing system 130, while still enabling movement about at least one axis of the adjustable mounting assembly 100 (e.g., about the roll axis). For example, the gasket 152 may provide enough friction between the intermediate member 132 and the front member 101 such that the front member 101 is rotatable, with respect to the intermediate member, about the roll axis; however, such rotation requires some rotational force on the front member 101 (e.g., from an installer) to overcome the friction of the gasket 152.

The exploded view of FIG. 1B is an example stack-up of components for the adjustable mounting assembly 100. In this example, when the adjustable mounting assembly 100 is assembled, adjacent components illustrated in the stack-up will abut and/or be engaged with one another. While this is illustrative of one example of a stack-up for the adjustable mounting assembly 100, the positional ordering of the components of the adjustable mounting assembly 100 may be in another order and/or may be assembled in alternative fashions. A stack-up of components (or alternative configuration for assembly) for the adjustable mounting assembly 100 may take various other forms, as well.

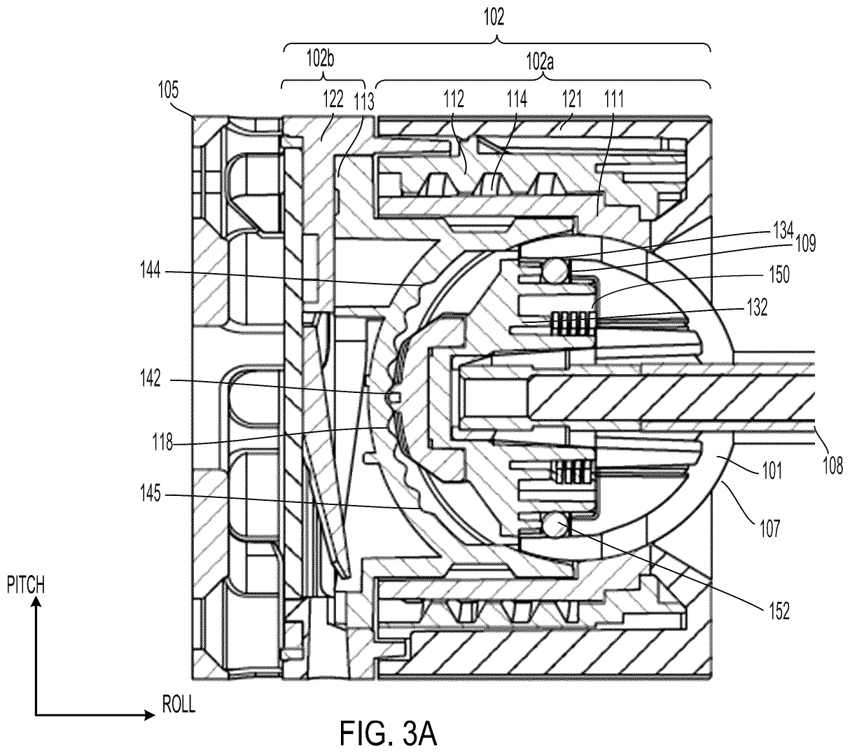

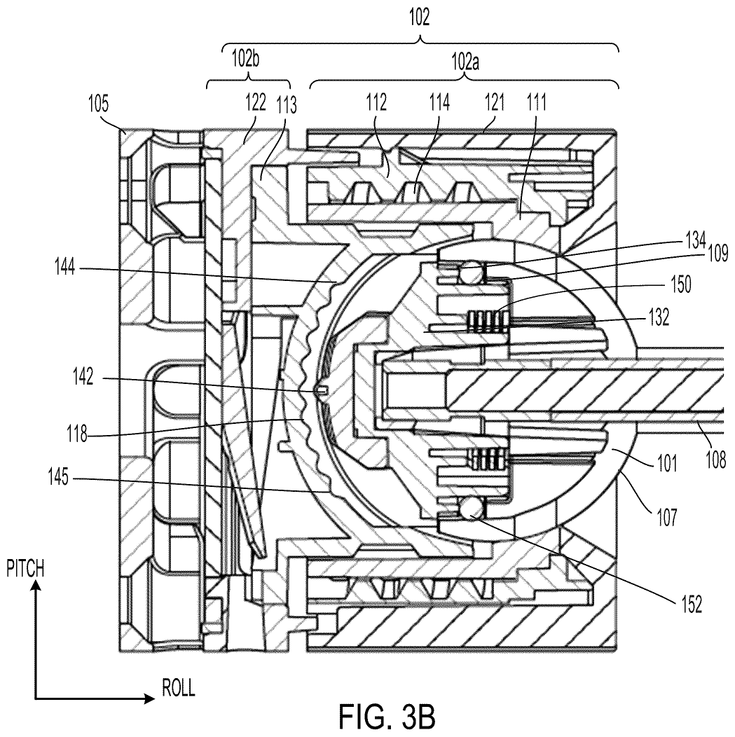

Referring now to FIGS. 2A-3B, various cross-sectional views of the adjustable mounting assembly 100 are illustrated. With specific reference to FIGS. 2A, 2B, cross-sectional side views of the adjustable mounting assembly 100 are illustrated that show the adjustable mounting assembly sectioned along a plane defined by the yaw and roll axes of the adjustable mounting assembly 100. Alternative cross-sectional top-down views of the adjustable mounting assembly 100 are illustrated FIGS. 3A, 3B that show the adjustable mounting assembly 100 sectioned along a plane defined by the pitch and roll axes of the adjustable mounting assembly 100. Each of these views focus on the components internal to the housing 102 and the internal indexing system 130, while omitting most of the platform 103.

Extending through the opening of the front collar 111 and the front cover 121 is the front member 101. As shown in FIGS. 2A-3B, the front member 101 includes a spherical front face 107 that is shaped to abut an interior bearing collar 106 of the front collar 111 that surrounds the opening, which serves to hold the front member 101 in place in conjunction with further components that will be discussed below. The front member 101 also includes a stem 108 that extends radially outward from the spherical front face 107 at the opening and serves to link the front member 101 with the platform 103. For instance, the platform 103 may be fastened to the stem 108 portion of the front member 101 with a screw, although numerous other arrangements are also possible.

The rear collar 113 may include one or more threads, such as the thread 114, that is engaged with one or more threads of the front collar 111, such as the thread 112. As will be discussed in further detail below, this may allow the front collar 111 and thus the entire front housing portion 102a to be translated either toward (i.e., tightening) or away from (i.e., loosening) the rear collar 113 and thus the entire rear housing portion 102b. In addition, the rear collar 113 may include a set of teeth 118 that are oriented toward the front collar 111, whose interaction will be discussed further in the following examples.

To that end, the cross-sectional views of FIG. 2A and FIG. 3A illustrate the adjustable mounting assembly 100 when the threaded engagement between the front collar 111 and the rear collar 113 are tightened to a first position. In the first position, the internal components of the housing, including the internal indexing system 130, abut each other in such a way that rotations of the front member 101 about either the pitch axis or the yaw axis of the adjustable mounting assembly 100 are prevented. In particular, opposing sets of ribs and teeth within the internal indexing system 130 are engaged and cannot move with respect to each other. Alternatively, the cross-sectional views of FIG. 2B and FIG. 3B, discussed further below, illustrate the adjustable mounting assembly 100 when the threaded engagement between the front collar 111 and the rear collar 113 are loosened to a second position, creating a gap 170 between the front housing portion 102a and the rear housing portion 102b. This gap 170 allows the front member 101 to rotate about the yaw axis or the pitch axis of the adjustable mounting assembly 100 with an indexable, limited range of motion.

This indexed motion of the adjustable mounting assembly 100, in both the pitch and yaw directions, is enabled via the spring 150, in conjunction with the translatability of the front housing portion 102a, away from the rear housing portion 102b, by way of the threaded engagement between the front collar 111 and the rear collar 113. In this regard, the spring is positioned within the housing 102 and is arranged to bias the intermediate member 132 and the front member 101 away from each other, which in turn biases a first rib 141 of the rear member 140 into the teeth 118 of the rear collar 113 (see FIG. 2B) and further biases a second rib 142 of the rear member 140 into the teeth 136 of the intermediate member 132 (see FIG. 3B). In this configuration, the biasing force of the spring 150 pushes the ribs of the rear member 140 into the opposing sets of teeth on both the rear collar 113 and the intermediate member 132, as the spring 150 lengthens to fill the gap 170. This engagement of the ribs and teeth, while in the second position, may be secure enough to prevent unwanted movement of the front member 101 when adjusting between indexable pitch and yaw directional positions (e.g., pitch rotations due to the weight of an object on the platform 103).

However, when the threaded engagement between the front collar 111 and the rear collar 113 is loosened to the second position, the first rib 141 may nonetheless be moveable over the teeth 136 of the intermediate member 132 by applying a sufficient rotational force in the pitch direction to compress the spring 150. Similarly, the second rib 142 may be moveable over the teeth 118 of the rear collar 113 by applying a sufficient rotational force in the yaw direction to compress the spring 150. This arrangement allows the front member 101 to rotate about the pitch axis or the yaw axis of the adjustable mounting assembly 100, each of which will be discussed in further detail below.

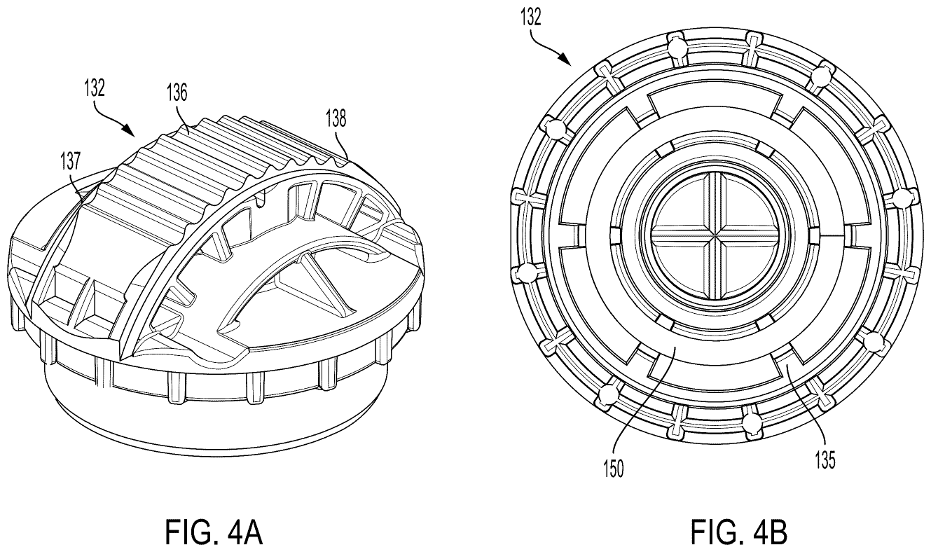

As illustrated in the two-dimensional front view of the intermediate member 132 of FIG. 4B (showing the side of the intermediate member 132 that faces the rear opening of the front member 101), the spring 150 may reside within a groove 135 of the intermediate member 132. In this regard, the spring 150 may be ring-shaped (e.g., a coil spring, a multiwave spring, a disc spring, etc.). The spring 150 may comprise of any suitable elastic material for providing a biasing force (e.g., a metal material, a rubber material, a plastic material, a synthetic elastic material, etc.).

However, it is contemplated that the spring 150 may be of various other forms and may be positioned between other components of the internal indexing system 130, such that it can provide the requisite biasing force.

FIGS. 2B and 3B demonstrate this capability and illustrate the adjustable mounting assembly 100 after the threaded engagement between the front collar 111 and the rear collar 113 after has been loosened from a first position (shown in FIGS. 2A, 2B) to a second position. For example, the front housing portion 102a may be rotated about the roll axis of the adjustable mounting assembly 100 such that the thread(s) 112 of the front collar 111 and the thread(s) 114 of the rear collar 113 move the front housing portion 102a away from the rear housing portion 102b. This may create a gap 170 between these parts of the housing 102, as seen at the top and bottom of the adjustable mounting assembly 100 in FIGS. 2B, 3B.

In this configuration, a user may adjust the orientation of the front member 101, and thus the platform 103, in accordance with the aforementioned indexable movements. Once a desired orientation is achieved, the threaded engagement between the front collar 111 and the rear collar 113 may be tightened back to the first position shown in FIGS. 2A and 3A. For instance, the front housing portion 102a may be rotated in the opposite direction about the roll axis of the adjustable mounting assembly 100 such that the thread(s) 112 of the front collar 111 and the thread(s) 114 of the rear collar 113 move the front housing portion 102a back toward the rear housing portion 102b.

As discussed further below, when the adjustable mounting assembly 100 is in the unlocked position as shown in FIGS. 2B, 3B, there may be a limit to the amount of rotation that may occur in each of the respective rotational directions. These limits may be imposed by a set of mechanical stops within the housing 102 with respect to the yaw direction and the pitch direction.

Referring again to FIGS. 2A-3B, it may be desirable to limit the separation of the front housing portion 102a and the rear housing portion 102b when the threaded engagement of the front collar 111 and the rear collar 113 is loosened to the second position shown in FIG. 2B, and/or when the threaded engagement is tightened to the first position shown in FIG. 2A. For example, it may be desirable to limit loosening the front collar 111 from the rear collar 113 to the point that the housing 102 can be fully disassembled, which may cause the body parts in the interior of the housing 102 to fall out. Additionally, or alternatively, it may be desirable to limit tightening the front collar 111 from the rear collar 113 to avoid over-tightening and damaging the adjustable mounting assembly 100.

Pitch and yaw-direction movement may be facilitated via the engagement between the intermediate member 132 and the rear member 140. As illustrated in FIGS. 2A-3B, the rear member 140 is positioned within the housing 102 between the rear collar 113 and the intermediate member 132. The rear member 140 comprises a first rib 141 (See: FIGS. 2A, 2B) that is oriented towards the rear collar 113 and a second rib 142 that is oriented towards the front collar 111 (See: FIGS. 3A, 3B).

Referring now to FIGS. 2A and 2B, pitch-direction movement may be facilitated via the engagement between the rear member 140 and the rear collar 113. The first rib 141 may be movable, in an indexable fashion, over the teeth 118 of the rear collar 113. The teeth 118 may include any number of adjacent teeth between which the first rib 141 may be positioned when the front member 101 is rotated in the pitch direction.

When the first rib 141 is moveable over the teeth of the rear collar 113, the first rib 141 may engage the teeth 118 that extend between an interior top wall 144 and an interior bottom wall 145 of the rear collar 113. Accordingly, rotation of the front member 101 about the pitch axis may be limited in a first direction by an abutment of the rear member 140 with the interior top wall 144 and rotation of the rear member 140 may be limited in a second direction by an abutment of the rear member 140 with interior bottom wall 145.

The movement of the first rib 141 over the teeth 118 may provide an indexable form of pitch-direction movement for the adjustable mounting assembly 100. In this way, each respective position of the first rib 141 between adjacent pairs of teeth 118 corresponds to an indexable position, in the pitch direction, for the adjustable mounting assembly 100. Further, the passing of the first rib 141 over each tooth may produce an audible click as the spring 150 is compressed and then the first rib 141 reengages with the teeth 118. This may provide a beneficial reference for an installer that is adjusting the orientation of the mounting assembly. For instance, an installer may wish to mount a set of playback devices along a wall in a commercial establishment that all have the same pitch angle with respect to the space. By using the adjustable mounting assembly 100 and internal indexing system 130 discussed herein, each playback device in the set may be adjusted based on the same number of “clicks” away from the starting, neutral position. For instance, each playback device in the set may be mounted relatively high on the wall and each rotated downward in the pitch direction by three clicks, providing a both consistent output angle for the audio content as well as a consistent visual appearance.

In some examples, this movement may enable the adjustable mounting assembly 100 to be adjusted to have a maximum pitch angle of 22.5 degrees in both the first (e.g., up) and second (e.g., down) directions, resulting in a total range of motion of 45 degrees about the pitch axis. Other angles are also possible (e.g., 10 degrees, 20 degrees, etc.), including implementations in which the limits in the two possible yaw directions are different.

Referring now to FIGS. 3A and 3B, yaw-direction movement may be facilitated via movement of the second rib 142, in an indexable fashion, over teeth 136 of the intermediate member 132. The teeth 136 may include any number of adjacent teeth between which the second rib 142 may be positioned when the front member 101 is rotated in the yaw direction. With reference to a perspective view of the intermediate member 132 in FIG. 4A, when the second rib 142 is moveable over the teeth 136 of the intermediate member 132, the second rib 142 may engage the teeth 136 that extend between a first yaw stop wall 137 and a second yaw stop wall 138 of the intermediate member 132. Accordingly, rotation of the front member 101 about the yaw axis may be limited in a first direction by an abutment of the rear member 140 with the first yaw stop wall 137 and rotation of the rear member 140 may be limited in a second direction by an abutment of the rear member 140 with the second yaw stop wall 138 of the intermediate member 132.

The movement of the second rib 142 over the teeth 136 may provide an indexable form of yaw-direction movement for the adjustable mounting assembly 100. In this way, each respective position of second rib 142 between adjacent pairs of teeth 136 corresponds to an indexable position, in the yaw direction, for the adjustable mounting assembly 100. Further, as discussed above with respect to pitch rotation, the passing of the second rib 142 over each tooth may produce an audible click as the spring 150 is compressed and then the second rib 142 reengages with the teeth 136. This may provide a beneficial reference for an installer that is adjusting the yaw orientation of the mounting assembly, similar to the discussion above regarding pitch rotations.

Moreover, a desired orientation for the mounting assembly may include both indexed pitch and indexed yaw rotations. For example, an installer may be able to easily adjust the angle of the adjustable mounting assembly to a pre-set orientation with reference to the indexing system discussed here (e.g., one click down and two clicks right). This may facilitate the quick and accurate installation of multiple playback devices having the same orientation (e.g., in a large listening space) as well as the accurate re-orientation of a playback device to its original indexed position after it is moved or adjusted. The internal indexing system 130 may provide other benefits, as well.

In some examples, this movement may enable the adjustable mounting assembly 100 to be adjusted to have a maximum yaw angle of 22.5 degrees in both the first (e.g., right) and second (e.g., left) directions, resulting in a total range of motion of 45 degrees about the yaw axis. Other angles are also possible (e.g., 10 degrees, 20 degrees, etc.), including implementations in which the limits in the two possible yaw directions are different.

As will be appreciated from the discussion above, the separation of the front housing portion 102a from the rear housing portion 102b to create the gap 170 provides the necessary space within the housing 102 for the opposing ribs and teeth to disengage from each other enough to move in the indexed fashion described herein. This is because in the first position, when the threaded engagement of the front and rear collars is tightened, there may be direct abutment from the front member 101, to the intermediate member 132, to the rear member 140, to the rear collar 113, such that all of the ribs and opposing teeth are engaged and there is no space for these members to disengage from one another to allow for relative movement. In the second position, when the gap 170 that is created by loosening the threaded engagement of the front and rear collars, both indexed pitch rotations (e.g., involving the movement of the first rib 141 over the teeth 118) and indexed yaw rotations (e.g., involving the movement of the second rib 142 over the teeth 136) are contemplated. In this regard, the adjustable mounting assembly 100 may be configured such that only one of these types of rotations is possible at a time. For example, in some implementations, the gap 170 that is created when the housing 102 is in the second position may only be wide enough for one of the ribs-either the first rib 141 or the second rib 142—to disengage from its opposing teeth. Further, the two types of disengagement occur in opposite directions with respect to the rear member 140. As a result, rotating the mounting assembly in the pitch direction separates the first rib 141 from the teeth 118 of the rear collar 113, pushing the rear member 140 forward (e.g., to the right in FIG. 2B) which necessarily forces the second rib 142 against the teeth 136 of the intermediate member 132 and prevents simultaneous yaw rotations. And conversely, rotating the mounting assembly in the yaw direction separates the second rib 142 from the teeth 136 of the intermediate member 132, pushing the rear member 140 back (e.g., to the left in FIG. 3B) which necessarily forces the first rib 141 against the teeth 118 of the rear collar 113 and prevents simultaneous pitch rotations. This arrangement may be beneficial in some situations, providing clarity around which rotational direction (i.e., pitch or yaw) is being adjusted for each indexed movement (i.e., each “click”) of the internal indexing system 130.

Within the housing 102, the front member 101 may be rotated about the roll axis, the yaw axis, and/or the pitch axis in manners that may be controlled and limited via the internal indexing system 130. To achieve this, intermediate member 132 of the internal indexing system 130 is rotatably engaged, about the roll axis of the adjustable mounting assembly 100, with the front member 101. The front member 101 may comprise a rear opening that has an outer edge 109 that is configured to receive a rib 134 of the intermediate member 132. The intermediate member 132, via the rib 134, is rotatable within the outer edge 109 when the front member 101 (and the attached platform 103) is rotated about the roll axis of the mounting assembly. This rotation within the outer edge 109 may be limited via the gasket 152, which provides some friction between the front member 101 and the intermediate member 132, during rotation about the roll axis.

In some examples, the front member 101 may be rotatable about the roll axis whether or not the threaded engagement between the front collar 111 and the rear collar 113 is in the first position or the second position. Alternatively, in some examples, the tightened first position may provide greater friction against the gasket 152 and thus roll-direction rotation may be more limited when the threaded engagement between the front collar 111 and the rear collar 113 is in the first position.

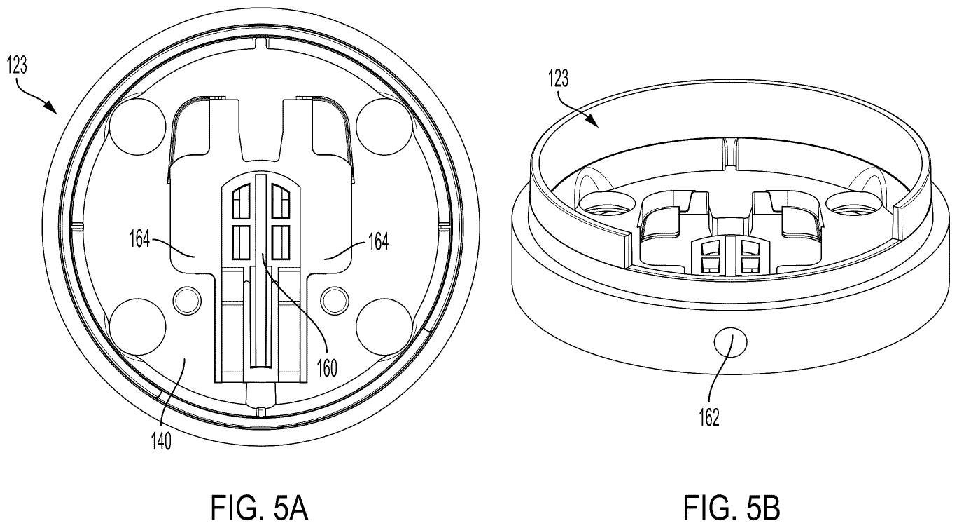

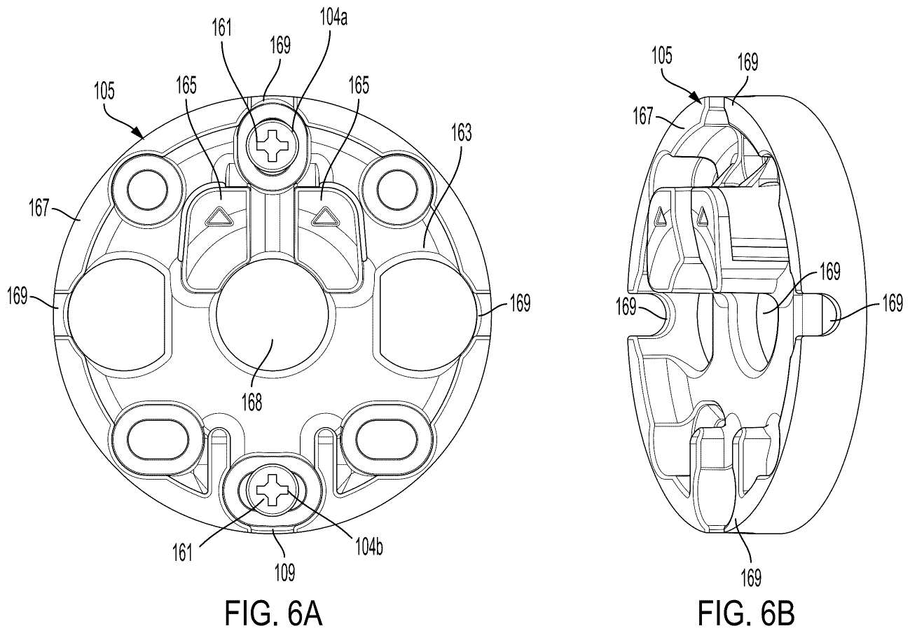

The mounting bracket 105 can also be seen in FIGS. 2A-3B, which can be removably coupled with the rear wall 155 and rear cover 123 of the rear housing portion 102b. More detailed views of the rear cover 123 are illustrated in FIGS. 5A and 5B, showing a side view of the rear cover 123 (FIG. 5A) and a perspective view of the rear cover 123, illustrating additional features and openings (FIG. 5B). More detailed views of the mounting bracket 105 are illustrated in FIGS. 6A and 6B, showing a two-dimensional front view of the interface to which the rear wall 155 may be removably coupled to the mounting bracket 105 (FIG. 6A) and a perspective view of the mounting bracket 105 that illustrates additional features and openings (FIG. 6B).

As best illustrated in FIG. 6A, the mounting bracket 105 includes one or more openings 161 to receive respective fasteners for attaching the mounting bracket 105 to a mounting surface, such as a wall. For instance, as shown in the example of FIG. 1A, screws 104a and 104b may pass through the openings 161 to attach the mounting bracket 105 to a mounting surface.

In some examples, the mounting bracket 105 may include one or more openings to facilitate the routing of cables to a playback device that is mounted on the platform 103. To that end, the mounting bracket 105 may comprise one or more rear openings 168, side openings 169, or combinations thereof. For instance, a rear opening 168 may be an opening in a rear wall of the mounting bracket 105 that is configured to receive a cable though the mounting surface (e.g., a network or power cable routed through a wall). Further, the side openings 169 may be openings in a side wall 167 of the mounting bracket 105 that are configured to route a cable exterior to the mounting bracket 105 and/or the adjustable mounting assembly 100, as a whole. To that end, such a cable may be routed through a mounting surface (e.g., via the rear opening 168), then routed to the platform 103 (e.g., via the side openings) wherein it can then interact with a playback device on the platform 103 (e.g., connecting the cable to the playback device). Alternatively, such a cable may only be routed through the side openings 169 to manage cable placement, proximate to the adjustable mounting assembly 100.

With the mounting bracket 105 securely installed on the mounting surface, the housing 102 and an attached playback device may then be removably coupled to the mounting bracket 105, via one or more mounting features, discussed below.

In some examples, rear wall 155 may be configured to be removably coupled with the mounting bracket 105 for secure placement that still enables relatively uncomplicated installation by a user. The mounting bracket 105 may be removably couplable to the rear wall 155 and the rear cover 123 via interaction between one or more hooks 165 of the mounting bracket and one or more openings 164 in the rear wall 155 and the rear cover 123. To that end, the one or more openings 164 may be configured to receive the one or more hooks 165, when the housing 102 is to be mounted to a mounting surface via the mounting bracket 105.

As an additional feature, in some examples the rear cover 123 may comprise a locking mechanism that engages with the mounting bracket 105 upon insertion of the one or more hooks 165 into the one or more openings 164 of the rear wall 155. For instance, the locking mechanism may take the form of a locking tab 160, which can be seen in FIGS. 5A and 5B. In addition, the locking tab 160 can be seen in the cross-sectional view of FIGS. 2A and 2B. This locking tab 160 may prevent removal of the one or more hooks 165 from the one or more openings 164.

For example, and with reference to FIGS. 5A-6B, an installer may removably couple the housing 102 to the mounting bracket 105 by initially inserting the hooks 165 of the mounting bracket 105 through the larger, lower portion of the openings 164 in the rear wall 155 and rear cover 123. In doing so, the forward face of the hooks 165 may bias the locking tab 160 forward (e.g., to the right in FIGS. 2A and 2B). Once the rear wall 155 of the housing 102 is flush against the mounting bracket 105, an installer may slide the housing 102 downward such that the narrower portions 165a of the hooks 165 moves upward into the narrower slots of the openings 164. As the hooks 165 reach the top of the openings 164, the forward face of the hooks 165 disengage with the locking tab 160, which returns (e.g., to the left in FIGS. 2A and 2B) to its original position. This may be accompanied by an audible click as the locking tab 160 passes over the hooks 165, beneficially indicating that the housing 102 is successfully mounted. Further, the locking tab 160 is now positioned directly below the hooks 165. As a result, movement of the housing 102 is now prevented in the upward direction.

In some such examples, the rear cover 123 may comprise a lock opening 162, through which an installer may insert an object to disengage the locking tab 160 from the hooks 165. As shown in FIGS. 2A and 2B, the locking tab 160 may include an inclined member that, when biased upward from below (e.g., via the lock opening 162) will also be biased forward (e.g., to the right in FIGS. 2A and 2B. This, in turn, may disengage the top of the locking tab 160 from the bottom of the hooks 165 and allow the housing 102 to be slid upward to be removed from the mounting bracket 105. For example, the lock opening 162 may be configured to have a relatively small diameter, such that only small objects with sufficient length (e.g., a small screwdriver, an allen wrench, etc.) are capable of fitting within the lock opening 162 to bias the inclined member of the locking tab 160 to remove the housing 102 from the mounting bracket 105.

It should be understood that the locking mechanism is not limited to the locking tab 160 discussed above and may take various other forms for internally securing the housing 102 to the mounting bracket 105.

Further, removable coupling of a housing 102 to a mounting bracket 105 is not limited to the configuration of openings 164 and hooks 165 discussed above. Rather, this removable coupling may be achieved via various other mechanical forms (e.g., other connectors, other mating surfaces, etc.).

In the discussion above, it should be understood that the features described and shown in the figures represent one possible implementation of the adjustable mounting assembly 100, and that other substantially similar configurations are also possible. For instance, where two parts are engaged via a rib and corresponding teeth, the rib and teeth may be swapped between the parts to produce the same effect. Similarly, any function that is discussed as being performed by a single part may be performed by two or more parts working in unison. Further, two or more of the parts discussed above may be combined into a single part, where appropriate. Numerous other variations are also possible.

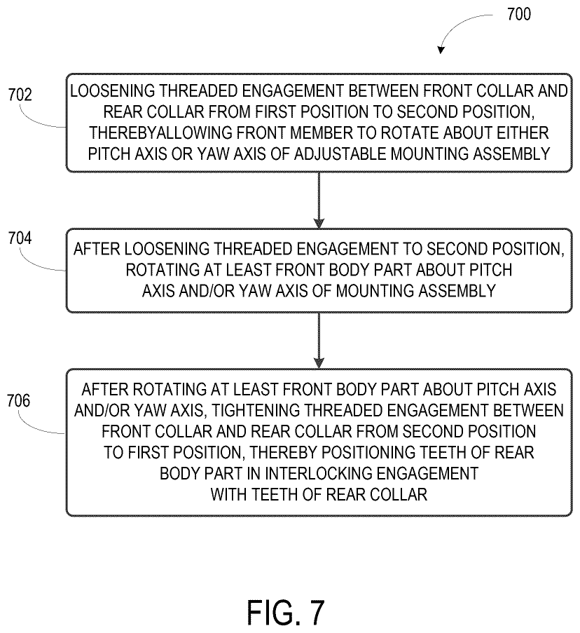

Turning now to FIG. 7, a process 700 for adjusting an adjustable mounting assembly is shown, according to an example implementation. For purposes of discussion in the following examples, the process 700 shown in FIG. 7 will refer to the adjustable mounting assembly 100 as shown in FIGS. 1-6. Alternative implementations are included within the scope of the examples of the present disclosure, in which functions may be executed out of order from that shown or discussed, including substantially concurrently, depending on the functionality involved, as would be understood by those reasonably skilled in the art.

At block 702, the process 700 may involve loosening the threaded engagement between the front collar 111 and the rear collar 113 from a first position, as shown in FIGS. 2A and 3A, to a second position, as shown in FIGS. 2B and 3B, thereby enabling the first rib 141 to move over the teeth 118 of the rear collar 113 by compressing the spring 150, or the second rib 142 to move over the teeth 136 of the intermediate member 132 by compressing the spring 150, and allowing the front member 101 to rotate about either a pitch axis or a yaw axis of the adjustable mounting assembly 100.

At block 704 of the process 700, after loosening the threaded engagement to the second position, the process 700 may involve rotating at least the front member 101 about the pitch axis or the yaw axis of the adjustable mounting assembly 100. For example, as discussed above, a user may manually adjust the position of the platform 103 and thus the mounted object to a desired orientation via the indexable motion of the internal indexing system 130.

At block 706 of the process 700, after rotating at least the front member 101 about the pitch axis or the yaw axis, the process may involve tightening the threaded engagement between the front collar 111 and the rear collar 113 from the second position to the first position, thereby fixing the first rib 141 in an interlocking engagement with the teeth 118 of the rear collar 113 and fixing the second rib 142 in an interlocking engagement with the teeth 136 of the intermediate member 132, thereby preventing the front member 101 from rotating about either the pitch axis or the yaw axis of the adjustable mounting assembly 100.

In view of the discussion above, it will be appreciated that, although rotation about the pitch axis or yaw axis is prevented when the threaded engagement between the front collar 111 and the rear collar 113 is tightened, rotations in the roll direction might still be possible. For example, the tightening of the front collar 111 toward the rear collar 113 might not be so tight as to prevent (e.g., via friction) relative movements of the front member 101 with respect to the intermediate member 132, which may be all that is required to affect a rotation about the roll axis. In these implementations, one type of rotation (i.e., roll) may be accomplished after the pitch level and yaw level are set and the threaded engagement of the adjustable mounting assembly 100 is tightened.

Alternatively, in some other implementations, the tightening of the threaded engagement between the front collar 111 and the rear collar 113 may snug the front, intermediate, and rear members together tightly enough within the housing 102 that friction may prevent the relative movements discussed above. Accordingly, in these implementations, adjustments in all rotational directions must be made prior to tightening the threaded engagement of the adjustable mounting assembly 100.

By the term “about” or “substantial” and “substantially” or “approximately,” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

The description of the different advantageous arrangements has been presented for purposes of illustration and description and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

### III. Conclusion

The description above discloses, among other things, various example systems, methods, apparatuses, and articles of manufacture including, among other components, firmware and/or software executed on hardware. It is understood that such examples are merely illustrative and should not be considered as limiting. For example, it is contemplated that any or all of the hardware, firmware, and/or software aspects or components can be embodied exclusively in hardware, exclusively in firmware, exclusively in software, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, components, procedures, steps, logic blocks, processing, and other symbolic representations. These process descriptions and representations are typically used by those skilled in the art to convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, components, procedures, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

We claim:

1. An adjustable mounting assembly comprising:
a housing comprising a front collar and a rear collar joined by a threaded engagement, the front collar comprising an opening about a roll axis of the mounting assembly, the rear collar comprising teeth oriented toward the front collar; and
an internal indexing system comprising:
a front member positioned within the housing and extending outwardly through the opening;
an intermediate member positioned within the housing and rotatably engaged, about the roll axis of the mounting assembly, with the front member, the intermediate member comprising teeth oriented towards the rear collar;
a rear member positioned within the housing between the rear collar and the intermediate member, the rear member comprising a first rib oriented towards the front collar and a second rib oriented towards the rear collar; and
a spring positioned within the housing, the spring arranged to bias (i) the first rib into the teeth of the intermediate member and (ii) the second rib into the teeth of the rear collar; and
wherein the adjustable mounting assembly is adjustable such that:
when the threaded engagement between the front collar and the rear collar is tightened to a first position, the first rib is fixed in an interlocking engagement with the teeth of the intermediate member and the second rib is fixed in an interlocking engagement with the teeth of the rear collar, thereby preventing the front member from rotating about either a pitch axis or a yaw axis of the mounting assembly; and
when the threaded engagement between the front collar and the rear collar is loosened to a second position, the first rib is moveable over the teeth of the intermediate member by compressing the spring or the second rib is moveable over the teeth of the rear collar by compressing the spring, thereby allowing the front member to rotate about the yaw axis or the pitch axis of the mounting assembly.

2. The adjustable mounting assembly of claim 1, wherein the front member comprises a rear opening having an outer edge, the outer edge sized to receive a rib of the intermediate member, wherein the rib of the intermediate member is rotatable within the outer edge when the front member is rotated about a roll axis of the mounting assembly.

3. The adjustable mounting assembly of claim 1, wherein the spring is positioned in between the intermediate member and the front member, seated within a groove of the intermediate member.

4. The adjustable mounting assembly of claim 1, wherein, when the threaded engagement between the front collar and the rear collar is loosened to the second position, the second rib is moveable over the teeth of the rear collar by compressing the spring while the first rib remains fixed in an interlocking engagement with the teeth of the intermediate member, thereby allowing the front member to rotate about the yaw axis of the mounting assembly.

5. The adjustable mounting assembly of claim 1, wherein, when the threaded engagement between the front collar and the rear collar is loosened to the second position, the first rib is moveable over the teeth of the intermediate member by compressing the spring while the second rib remains fixed in an interlocking engagement with the teeth of the rear collar, thereby allowing the front member, the intermediate member, and the rear member to rotate about the pitch axis of the mounting assembly.

6. The adjustable mounting assembly of claim 1, wherein, when the threaded engagement between the front collar and the rear collar is loosened to the second position, rotation of the front member about the yaw axis is limited in a first direction by an abutment of the rear member with a first yaw stop wall of the intermediate member, and rotation of the front member about the yaw axis is limited in a second direction by an abutment of the rear member with a second yaw stop wall of the intermediate member.

7. The adjustable mounting assembly of claim 1, wherein, when the threaded engagement between the front collar and the rear collar is loosened to the second position, rotation of the front member about the pitch axis is limited in a first direction by an abutment of the rear member with an interior top wall of the rear collar, and rotation of the front member about the pitch axis is limited in a second direction by an abutment of the rear member with an interior bottom wall of the rear collar.

8. The adjustable mounting assembly of claim 1, wherein the housing further comprises a bearing collar radially inward from the rear collar and comprising a bearing surface surrounding the opening, and wherein the front member comprises:
a spherical front face shaped to abut the bearing surface of the bearing collar; and
a stem that extends radially outward from the spherical front face at the opening of the front collar.

9. The adjustable mounting assembly of claim 8, wherein the stem is coupled to a platform for receiving an audio playback device.

10. The adjustable mounting assembly of claim 9, wherein the stem is coupled to the platform for receiving an audio playback device weighing at least 5 pounds.

11. The adjustable mounting assembly of claim 1, further comprising:
a mounting bracket that is removably coupleable to a rear surface of the housing, the mounting bracket comprising one or more openings to receive respective fasteners for attaching the mounting bracket to a mounting surface.

12. The adjustable mounting assembly of claim 11, wherein the mounting bracket comprises one or more hooks, and wherein the rear surface of the housing comprises one or more openings sized to receive the one or more hooks.

13. The adjustable mounting assembly of claim 12, wherein the housing further comprises a locking assembly that engages with the mounting bracket upon insertion of the one or more hooks into the one or more openings of the rear surface, thereby preventing removal of the one or more hooks from the one or more openings of the rear surface.

14. The adjustable mounting assembly of claim 12, wherein the mounting bracket comprises a back wall and a radial wall that surrounds the back wall,
wherein the back wall comprises a rear opening configured to receive a cable through the mounting surface, and
wherein the radial wall comprises one or more side openings that are configured to route the cable exterior to the mounting bracket.

15. A method of adjusting an adjustable mounting assembly, the mounting assembly comprising:
a housing comprising a front collar and a rear collar joined by a threaded engagement, the front collar comprising an opening about a roll axis of the mounting assembly, the rear collar comprising teeth oriented toward the front collar; and
an internal indexing system comprising (i) a front member positioned within the housing and extending outwardly through the opening; (ii) an intermediate member positioned within the housing and rotatably engaged, about the roll axis of the mounting assembly, with the front member, the intermediate member comprising teeth oriented towards the rear collar; (iii) a rear member positioned within the housing between the rear collar and the intermediate member, the rear member comprising a first rib oriented towards the front collar and a second rib oriented towards the rear collar; and (iv) a spring positioned within the housing, the spring arranged to bias (a) the first rib into the teeth of the intermediate member and (b) the second rib into the teeth of the rear collar;
the method comprising:
loosening the threaded engagement between the front collar and the rear collar from a first position to a second position, thereby (i) enabling the first rib to move over the teeth of the intermediate member by compressing the spring, (ii) enabling the second rib to move over the teeth of the rear collar by compressing the spring and (iii) allowing the front member to rotate about either a pitch axis or a yaw axis of the adjustable mounting assembly;
after loosening the threaded engagement to the second position, rotating at least the front member about the pitch axis or the yaw axis of the adjustable mounting assembly; and
after rotating at least the front member about the pitch axis or the yaw axis, tightening the threaded engagement between the front collar and the rear collar from the second position to the first position, thereby (i) fixing the first rib in an interlocking engagement with the teeth of the intermediate member, (ii) fixing the second rib in an interlocking engagement with the teeth of the rear collar, and (iii) preventing the front member from rotating about either the pitch axis or the yaw axis of the adjustable mounting assembly.

16. The method of claim 15, wherein the housing further comprises a bearing collar radially inward from the rear collar and comprising a bearing surface surrounding the opening, and wherein the front member comprises (i) a spherical front face shaped to abut the bearing surface of the bearing collar and (ii) a stem that extends radially outward from the spherical front face at the opening of the front collar, the stem coupled to a platform for receiving an audio playback device, the method further comprising:
attaching a playback device weighing at least 5 pounds to the platform.

17. The method of claim 15, wherein the front member comprises a rear opening having an outer edge, the outer edge sized to receive a rib of the intermediate member, the method further comprising:
rotating the front member about a roll axis of the mounting assembly by rotating the rib of the intermediate member within the outer edge.

18. The method of claim 15, wherein the adjustable mounting assembly further comprises a mounting bracket that is removably coupleable to a rear surface of the housing, the mounting bracket comprising one or more openings to receive respective fasteners for attaching the mounting bracket to a mounting surface, the method further comprising:
attaching the mounting bracket to the mounting surface by installing the respective fasteners in the one or more openings.

19. The method of claim 18, wherein the mounting bracket comprises one or more hooks, and wherein the rear surface of the housing comprises one or more openings sized to receive the one or more hooks,
wherein the housing further comprises a locking assembly that engages with the mounting bracket upon insertion of the one or more hooks into the one or more openings of the rear surface, thereby preventing removal of the one or more hooks from the one or more openings of the rear surface, the method further comprising:
attaching the housing to the mounting bracket by engaging the locking assembly with the mounting bracket.

20. The method of claim 18, wherein the mounting bracket comprises a back wall and a radial wall that surrounds the back wall,
wherein the back wall comprises a rear opening configured to receive a cable through the mounting surface, and
wherein the radial wall comprises one or more side openings that are configured to route the cable exterior to the mounting bracket, the method further comprising:
attaching a playback device adjustable mounting assembly; and
routing the cable to the playback device via one or more of the rear opening, the one or more side openings, or combinations thereof.
